(19) United States
(12) Patent Application Publication
(10) Pub. No.: US 2014/0062921 A1
(43) Pub. Date: Mar. 6, 2014

(54) DIGITIZER

(71) Applicant: SAMSUNG ELECTRO-MECHANICS CO., LTD., Suwon (KR)

(72) Inventors: Ho Yun Cho, Suwon (KR); Hee Bum Lee, Suwon (KR); Kyoung Soo Chae, Suwon (KR); Dong Sik Yoo, Suwon (KR); Yun Ki Hong, Suwon (KR)

(73) Assignee: SAMSUNG ELECTRO-MECHANICS CO., LTD., Suwon (KR)

(21) Appl. No.: 13/958,234

(22) Filed: Aug. 2, 2013

(30) Foreign Application Priority Data
Aug. 29, 2012 (KR) 10-2012-094825

(51) Int. Cl. G06F 3/041

(52) U.S. Cl. CPC G06F 3/041
USPC 345/173

(57) ABSTRACT

Disclosed herein is a digitizer, including: a transparent substrate that is partitioned into an active area and an inactive area at an outside of the active area; an electrode that is formed in the active area on one surface of the transparent substrate; a coil that is formed in the active area on one surface of the transparent substrate; and a magnetic sheet that is formed in the inactive area on the other surface of the transparent substrate corresponding to the coil.

### CROSS REFERENCE TO RELATED APPLICATION

This application claims the benefit of Korean Patent Application No. 10-2012-0094825, filed on Aug. 29, 2012, entitled “Digitizer”, which is hereby incorporated by reference in its entirety into this application.

### BACKGROUND OF THE INVENTION

1. Technical Field

The present invention relates to a digitizer.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, an electromagnetic induction type digitizer has been developed as an input device capable of inputting information such as text, graphics, or the like.

An example of the digitizer according to the prior art may include a digitizer disclosed in Korean Patent No. 10-0510729 as the prior art.

The digitizer disclosed in the Korean Patent No. 10-0510729 is configured to include a sensor unit disposed under a liquid crystal panel and transmitting and receiving electromagnetic waves resonated at a location at which an electronic pen is touched to recognize the touched location and a control unit controlling the sensor unit. Here, the sensor unit is configured to include a sensor PCB and a plurality of X-axis coils and Y-axis coils formed on the sensor PCB. Further, the control unit is disposed under the sensor unit and serves to transmit a signal to the sensor unit and read a signal input again to sense a location of an electronic pen. Moreover, the electronic pen includes a resonance circuit configured of a coil and a capacitor formed therein.

The digitizer according to the prior art is operated by transmitting a signal from the control unit to the sensor unit and generates electromagnetic waves while inducing electromagnetism by selecting the X-axis and Y-axis coils. The electronic pen is resonated by the generated electromagnetic waves and a resonance frequency is received by the sensor unit while being held for a predetermined time. The control unit reads the signal received by the sensor unit to sense the touched location.

However, the digitizer according to the prior art needs to include the electronic pen having a resonance circuit embedded therein so as to detect the touched location. Therefore, there is a problem in that an input unit used to detect the touched location is limited.

In addition, the digitizer according to the prior art has a problem in that a magnetic line of force radiated from the coil affects external circuits. Therefore, the digitizer according to the related art needs to be improved by disposing a separate magnetic field shielding unit so as not to affect the magnetic line of force generated from the coil on the external circuits.

### SUMMARY OF THE INVENTION

The present invention has been made in an effort to provide a digitizer having a capacitive type touch panel structure integrated therewith so as to detect a touched location and detecting writing pressure of an electronic pen.

Further, the present invention has been made in an effort to provide a digitizer having a magnetic field shielding unit so as not to affect a magnetic line of force radiated from a coil on external circuits.

According to a preferred embodiment of the present invention, there is provided a digitizer including: a transparent substrate that is partitioned into an active area and an inactive area at an outside of the active area; an electrode that is formed in the active area on one surface of the transparent substrate; a coil that is formed in the inactive area on one surface of the transparent substrate; and a magnetic sheet that is formed in the inactive area on the other surface of the transparent substrate corresponding to the coil.

The magnetic sheet may include a material formed by curing a mixture of a magnetic powder and a binder.

The magnetic powder may be an alloy powder including any one or at least two of Fe, Si, and Al.

The binder may include acrylonitrile-butadiene-styrene (ABS).

The digitizer may further include: a display unit that is adhered to the other surface of the magnetic sheet and is disposed in a direction of the other surface of the transparent substrate, wherein an air gap is formed between the transparent substrate and the display unit.

The electrode may be formed in a mesh pattern formed of metal.

The metal may be formed of any one selected from copper (Cu), aluminum (Al), gold (Au), silver (Ag), titanium (Ti), palladium (Pd), and chromium (Cr), or a combination thereof.

According to another preferred embodiment of the present invention, there is provided a digitizer including: a transparent substrate that is partitioned into an active area and an inactive area at an outside of the active area; an electrode that is formed in the active area on one surface of the transparent substrate; a coil that is formed in the inactive area on the other surface of the transparent substrate; and a magnetic sheet that is formed in the inactive area on the other surface of the transparent substrate so as to cover the coil.

The magnetic sheet may include a material formed by curing a mixture of a magnetic powder and a binder.

The magnetic powder may be an alloy powder including any one or at least two of Fe, Si, and Al.

The binder may include acrylonitrile-butadience-styrene (ABS).

The digitizer may further include: a display unit that may be adhered to the other surface of the magnetic sheet and is disposed in a direction of the other surface of the transparent substrate, wherein an air gap is formed between the transparent substrate and the display unit.

The electrode may be formed in a mesh pattern formed of metal.

The metal may be formed of any one selected from copper (Cu), aluminum (Al), gold (Au), silver (Ag), titanium (Ti), palladium (Pd), and chromium (Cr), or a combination thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a transparent substrate of a digitizer according to a first preferred embodiment of the present invention;

FIG. 2 is a plan view of main components of the digitizer according to the first preferred embodiment of the present invention;

FIGS. 3 and 4 are cross-sectional views of the digitizer according to the first preferred embodiment of the present invention; and

FIGS. 5 and 6 are cross-sectional views of a digitizer according to a second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

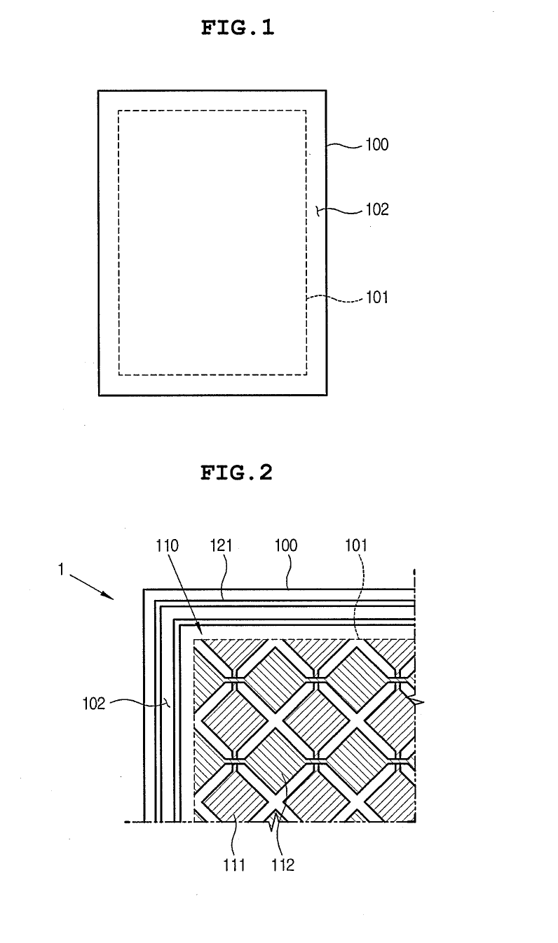

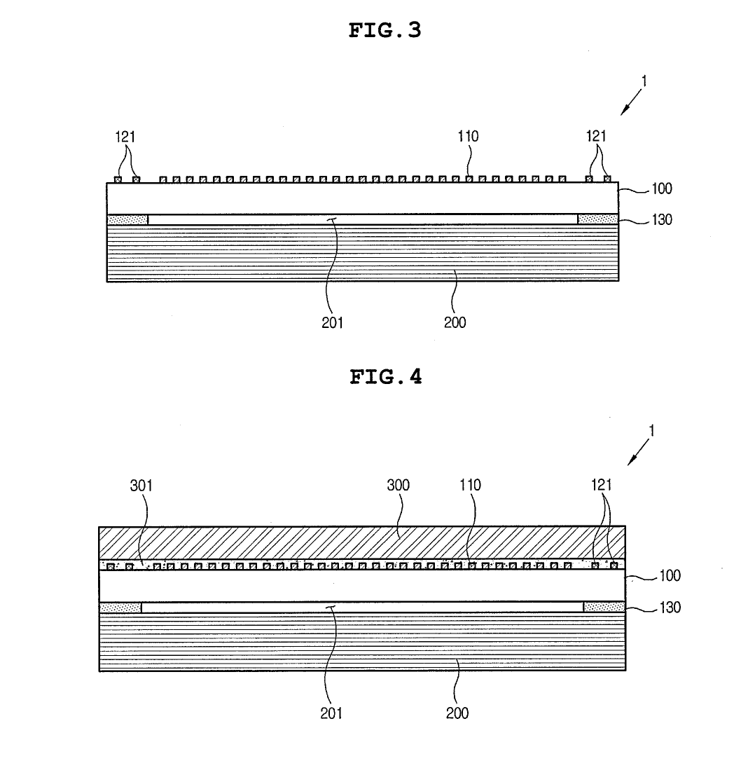

FIG. 1 is a diagram showing a transparent substrate of a digitizer according to a first preferred embodiment of the present invention and FIG. 2 is a plan view of main components of the digitizer according to the first preferred embodiment of the present invention. Further, FIGS. 3 and 4 are cross-sectional views of the digitizer according to the first preferred embodiment of the present invention.

As shown in FIGS. 1 to 3, a digitizer 1 according to a first preferred embodiment of the present invention includes a transparent substrate 100 partitioned into an active area 101 and an inactive area 102 at the outside of the active area 101, an electrode 110 formed in the active area 101 on one surface of the transparent substrate 100, a coil 121 formed in the inactive area 102 on one surface of the transparent substrate 100, and a magnetic sheet 130 formed in the inactive area 102 on the other surface of the transparent substrate 100 corresponding to the coil 121.

The digitizer 1 according to the preferred embodiment of the present invention is a digitizer in which a capacitive type touch panel structure is integrated. Therefore, the transparent substrate 100 and the electrode 110 included in the preferred embodiment of the present invention can be considered as a configuration included in the capacitive type touch panel structure.

The transparent substrate 100 provides an area in which the electrode 110 and the coil 121 to be described below are formed. The transparent substrate 100 needs to have support force capable of supporting the electrode 110 and the coil 121 and transparency to allow a user to recognize images provided from the display unit.

In consideration of the support force and the transparency described above, the transparent substrate 100 may be made of polyethylene terephthalate (PET), polycarbonate (PC), poly methyl methacrylate (PMMA), polyethylene naphthalate (PEN), polyethersulpon (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but are not necessarily limited thereto.

The one surface of the transparent substrate 100 is preferably activated by being subjected to high frequency treatment or primer treatment. The transparent substrate 100 is treated as described above, thereby more improving adhesion between the transparent substrate 100 and the electrode 110 and between the transparent substrate 100 and the coil 121.

As shown in FIG. 1, the transparent substrate 100 is partitioned into the active area 101 and the inactive area 102. The active area 101 is an area in which the electrode 110 is formed and may be referred to as an area in which the touched signal is generated. In addition, the inactive area 102 is partitioned from the active area 101 while occupying the outside of he active area 101.

When the user touches the electrode 110 using his/her finger or the electronic pen having a conductive tip formed therein, the electrode 110 generates a signal to allow a controller (not shown) to recognize the touched coordinates.

The electrode 110 may include, for example, a first electrode 111 and a second electrode 112. In this case, the first electrode 111 may be fanned on the active area 101 on one surface of the transparent substrate 100. Further, the first electrode 111 may be formed of metals consisting of any one selected from copper (Cu), aluminum (Al), gold (Au), silver (Ag), titanium (Ti), palladium (Pd), and chromium (Cr), or a combination thereof and may be formed on one surface of the transparent substrate 100 in mesh patterns by methods such as a plating process, an evaporation process, and the like. In this case, as shown in FIG. 2, the first electrode 111 may be formed on the transparent substrate 100 in diamond patterns arranged in a first direction and bridge patterns connecting between the diamond patterns.

The second electrode 112 may be formed together with the first electrode 111 in the active area 101 on one surface of the transparent substrate 100. The second electrode 112 may also be formed of metals consisting of any one selected from copper (Cu), aluminum (Al), gold (Au), silver (Ag), titanium (Ti), palladium (Pd), and chromium (Cr), or a combination thereof and may be formed in the mesh patterns. The second electrode 112 may be formed on the transparent substrate 100 in diamond patterns arranged in a second direction and bridge patterns connecting between the diamond patterns. In this case, the diamond patterns configuring the second electrode 112 may be formed so as to fill the transparent substrate 100 area that does not overlap the diamond patterns configuring the first electrode 111.

Any one of the first electrode 111 and the second electrode 112 may be used as a sensing electrode 110 and the other thereof may be used as a driving electrode 110.

Meanwhile, the electrode 110 is formed in the mesh patterns and is not necessarily formed in the diamond patterns as described above. The electrode 110 may be formed in various types of known patterns in addition to the diamond form.

In addition, the electrode 110 is not limited as being formed by the foregoing materials and processes. The electrode 110 may be formed of metal silver formed by exposing/developing a silver salt emulsion layer in addition to the foregoing metals or may also be formed of metal oxide or conductive polymer.

As shown in FIGS. 2 and 3, the coil 121 is formed on the inactive area 102 on one surface of the transparent substrate 100 to serve to receive the signal transmitted from the input unit (not shown). The input unit may be, for example, an electronic pen in which a writing pressure sensor is embedded. After the writing pressure applied to a tip portion of the electronic pen is measured by the writing pressure sensor, the electronic pen transmits the measured writing pressure to the coil 121 and the coils 121 and 122 receive the signal and transmit the received signal to the control unit (not shown).

The coil 121 may also serve as a power coil supplying power to the electronic pen. The electronic pen may be formed to have a structure in which the resonance circuit embedded in the electronic pen is supplied with AC power from the outside, but may be a powerless electronic pen that receives and resonates the electromagnetic force from the outside. The coil 121 may be controlled to be applied with the driving power by the control unit in a time interval in which power is supplied to the electronic pen and when the coil 121 discharges the electromagnetic force by the applied power, the resonance circuit of the electronic pen stores the input electromagnetic force and may use the stored electromagnetic force as the driving power of components embedded in the electronic pen.

Meanwhile, the electronic pen for the digitizer in which the writing pressure sensor or the resonance circuit is embedded is a component known in advance and therefore, the detailed description thereof will be omitted.

The magnetic sheet 130 is formed in the inactive area 102 on the other surface of the transparent substrate 100. The magnetic sheet 130 is formed in the inactive area 102 of the other surface of the transparent substrate 100 corresponding to a formation position of the coil 121 to perform a function of shielding the magnetic field radiated from the coil 121 with respect to the direction of the other surface of the transparent substrate 100.

The magnetic sheet 130 may include a material formed by curing a mixture of a magnetic powder and a binder. Here, the magnetic powder may be an alloy powder including any one or at least two of Fe, Si, and Al. In addition, the binder may be formed, including, for example, acrylonitrile-butadience-styrene (ABS).

The adhesive layer (not shown) may be formed on one surface of the magnetic sheet 130 contacting the transparent substrate 100 so that the magnetic sheet 130 may be adhered and fixed to the other surface of the transparent substrate 100.

Meanwhile, the preferred embodiment of the present invention may further include the display unit 200 that is disposed in the direction of the other surface of the transparent substrate 100.

The display unit 200 serves to provide the images and includes a liquid crystal display (LCD) device, and the like.

The display unit 200 may be adhered to the other surface of the foregoing magnetic sheet 130 and the other surface of the magnetic sheet 130 may be provided with the adhesive layer (not shown) so that the display unit 200 may be adhered to the other surface of the magnetic sheet 130.

The display unit 200 is adhered to the other surface of the magnetic sheet 130 and thus, the display unit 200 is disposed in the direction of the other surface of the transparent substrate 100. In this case, an air gap 201 is formed between the transparent substrate 100 and the display unit 200.

The air gap 201, which is a portion serving as a cushion, may absorb impact applied to the display unit 200. In the related art, a separate double-sided adhesive tape (DAT) has been used so as to form the air gap 201. However, in the preferred embodiment of the present invention, the double-sided adhesive tape is not used. Instead, the foregoing magnetic sheet 130 performs a function of the DAT.

Meanwhile, as shown in FIG. 4, the digitizer according to the preferred embodiment of the present invention may further include a window glass 300 that is disposed in a direction of one surface of the transparent substrate 100. The window glass 300 may be adhered to one surface of the transparent substrate 100 by an optical clear adhesive (OCA) 301.

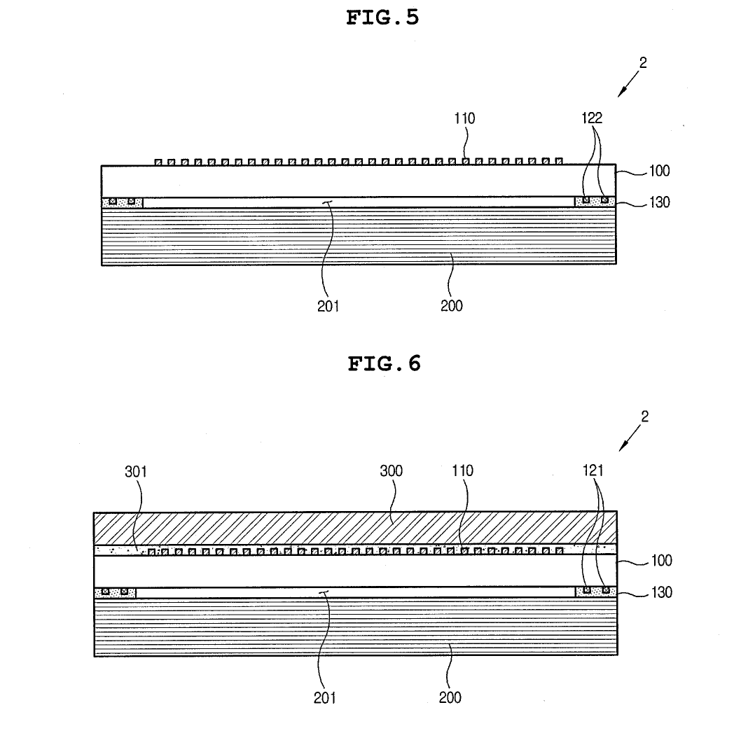

Hereinafter, a digitizer according to a second preferred embodiment of the present invention will be described with reference to the accompanying drawings. However, the overlapping contents with the contents described in the first preferred embodiment of the present invention will be omitted. FIGS. 5 and 6 are cross-sectional views of a digitizer according to a second preferred embodiment of the present invention.

As shown in FIG. 5, a digitizer 2 according to the preferred embodiment of the present invention includes the transparent substrate 100 partitioned into the active area 101 and the inactive area 102 at the outside of the active area 101, the electrode 110 formed in the active area 101 on one surface of the transparent substrate 100, the coil 122 formed in the inactive area 102 on the other surface of the transparent substrate 100, and the magnetic sheet 130 formed in the inactive area 102 on the other surface of the transparent substrate 100 so as to cover the coil 121.

The digitizer 2 according to the second preferred embodiment of the present invention has a difference in the formation position of the coil 122, comparing with the digitizer 1 according to the first preferred embodiment of the present invention. Therefore, only the difference thereof will be described below in detail.

The coil 122 included in the second preferred embodiment of the present invention is formed in the inactive area 102 of the transparent substrate 100 but is not formed in the inactive area 102 on one surface of the transparent substrate 100 but formed in the inactive area 102 on the other surface thereof as shown in FIG. 5.

The inactive area 102 on one surface of the transparent substrate 100 is an area in which the wiring (not shown) connected with the electrode 110 is formed. Therefore, when the coil 122 is formed in the inactive area 102 on one surface of the transparent substrate 100 as in the first preferred embodiment of the present invention, both of the coil 122 and the wiring are formed in the inactive area 102 on one surface of the transparent substrate 100 and thus, the width of the inactive area 102 may be increased.

Therefore, according to the present embodiment of the present invention, only the wiring is formed in the inactive area 102 on one surface of the transparent substrate 100 and the coil 122 is formed in the inactive area 102 on the other surface of the transparent substrate 100 so that the width of the inactive area 102 of the transparent electrode 100 is formed to be narrow.

Further, the magnetic sheet 130 is formed in the inactive area 102 on the other surface of the transparent substrate 100 while covering the coil 122.

Meanwhile, the second preferred embodiment of the present invention may further include the window glass 300 disposed in a direction of one surface of the transparent substrate 100 as in the first preferred embodiment of the present invention (see FIG. 6). Further, the window glass 300 may be adhered to one surface of the transparent substrate 100 by the optical clear adhesive (OCA) 301.

According to the preferred embodiments of the present invention, it is possible to diversify the input unit for detecting the touched location by integrating the digitizer structure in the touch panel structure.

Further, it is possible to detect the writing pressure while detecting the touched location by forming the coil for detecting the writing pressure using the inactive area of the transparent substrate.

In addition, it is possible to shield the magnetic field formed from the coil by disposing the magnetic sheet under the coil, thereby preventing the external devices such as the display unit, and the like, from being affected by the magnetic field.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A digitizer, comprising:
a transparent substrate that is partitioned into an active area and an inactive area at an outside of the active area;
an electrode that is formed in the active area on one surface of the transparent substrate;
a coil that is formed in the inactive area on one surface of the transparent substrate; and
a magnetic sheet that is formed in the inactive area on the other surface of the transparent substrate corresponding to the coil.

2. The digitizer as set forth in claim 1, wherein the magnetic sheet includes a material formed by curing a mixture of a magnetic powder and a binder.

3. The digitizer as set forth in claim 2, wherein the magnetic powder is an alloy powder including any one or at least two of Fe, Si, and Al.

4. The digitizer as set forth in claim 2, wherein the binder includes acrylonitrile-butadience-styrene (ABS).

5. The digitizer as set forth in claim 1, further comprising:
a display unit that is adhered to the other surface of the magnetic sheet and is disposed in a direction of the other surface of the transparent substrate,
wherein an air gap is formed between the transparent substrate and the display unit.

6. The digitizer as set forth in claim 1, wherein the electrode is formed in a mesh pattern formed of metal.

7. The digitizer as set forth in claim 6, wherein the metal is formed of any one selected from copper (Cu), aluminum (Al), gold (Au), silver (Ag), titanium (Ti), palladium (Pd), and chromium (Cr), or a combination thereof.

8. A digitizer, comprising:
a transparent substrate that is partitioned into an active area and an inactive area at an outside of the active area;
an electrode that is formed in the active area on one surface of the transparent substrate;
a coil that is formed in the inactive area on the other surface of the transparent substrate; and
a magnetic sheet that is formed in the inactive area on the other surface of the transparent substrate so as to cover the coil.

9. The digitizer as set forth in claim 8, wherein the magnetic sheet includes a material formed by curing a mixture of a magnetic powder and a binder.

10. The digitizer as set forth in claim 9, wherein the magnetic powder is an alloy powder including any one or at least two of Fe, Si, and Al.

11. The digitizer as set forth in claim 9, wherein the binder includes acrylonitrile-butadience-styrene (ABS).

12. The digitizer as set forth in claim 8, further comprising:
a display unit that is adhered to the other surface of the magnetic sheet and is disposed in a direction of the other surface of the transparent substrate,
wherein an air gap is formed between the transparent substrate and the display unit.

13. The digitizer as set forth in claim 8, wherein the electrode is formed in a mesh pattern formed of metal.

14. The digitizer as set forth in claim 13, wherein the metal is formed of any one selected from copper (Cu), aluminum (Al), gold (Au), silver (Ag), titanium (Ti), palladium (Pd), and chromium (Cr), or a combination thereof.
